(19) United States
(12) Patent Application Publication
(10) Pub. No.: US 2003/0161326 A1
(43) Pub. Date: Aug. 28, 2003

(54) Method and apparatus for data transmission

(76) Inventors: Rajesh S. Pazhyannur, Schaumburg, IL (US); Ivan N. Vukovic, Arlington Heights, IL (US)

Correspondence Address: MOTOROLA, INC., 1303 EAST ALGONQUIN ROAD, IL01/3RD, SCHAUMBURG, IL, 60196

(21) Appl. No.: 10/082,765

(22) Filed: Feb. 25, 2002

(51) Int. Cl. H04L 12/56

(52) U.S. Cl. 370/395.52; 370/537

(57) ABSTRACT

A method and apparatus for multiplexing higher-layer packets (110) into a single lower layer packet (112) is described herein. There exists an optimal frame size for a given bit error rate (BER). The optimal frame size provides the best trade off between frame size and capacity. The BER for a transmission media (205) is constantly monitored and the lower-layer packet size (112) is adjusted dynamically based on the BER.

### FILED OF THE INVENTION

The present invention relates generally to communication systems and in particular, to a method and apparatus for data transmission within such communication systems.

### BACKGROUND OF THE INVENTION

Point-to-Point Protocol multiplexing (PPPmux) is known in the art. As described in IEEE International Communications Conference 2001 (ICC2001) Proceedings PPPmux—A new Protocol for Transporting Small IP Packets, PPPmux is a protocol utilized to multiplex multiple higher-layer packets within a single lower-layer PPP frame. PPPmux offers higher capacity by reducing the protocol overhead corresponding to lower layers (e.g., UDP/IP). Higher efficiency is achieved because multiple IP packets share a common header as shown in FIG. 1. As shown, multiple UDP/IP packets 110 are multiplexed onto a single PPP packet 112. Each UDP/IP packet originally contains its own header information 101 and payload 102. After multiplexing, the PPP packet contains a single header 103 and the payload for the UDP/IP packets 110. Several techniques are utilized to identify individual UDP/IP payloads within the PPP packet. For example, as discussed in U.S. patent application Ser. No. 09/534,971, a frame header 104 may be placed at the beginning of the multiplexed UDP/IP packets.

Although not shown, a single Cyclic-Redundancy-Check (CRC) field covers the entire PPP payload. Thus, transmission link errors lead to dropping the entire PPP packet, and consequently the dropping of multiple TCP/IP packets contained therein (when multiplexing is used). Because of this, there exists a tradeoff between the benefits of having many UDP/IP packets within the PPPmux packet in order to reduce the packet overhead, and having a small number of UDP/IP packets within the PPPmux packet so that an error in transmission does not require retransmitting many UDP/IP packets. Therefore, a need exists for a method and apparatus for data transmission that effectively optimizes the amount of higher-layer packets multiplexed into a lower-layer packet.

### BRIEF DESCRIPTION OF THE DRAWINGS

FIG. 1 illustrates PPP multiplexing.

FIG. 2 is a block diagram of a communication system in accordance with the preferred embodiment of the present invention.

FIG. 3 is a more detailed block diagram of the communication system of FIG. 2 in accordance with the preferred embodiment of the present invention.

FIG. 4 is a flow chart showing operation of the communication system of FIG. 2 in accordance with the preferred embodiment of the present invention.

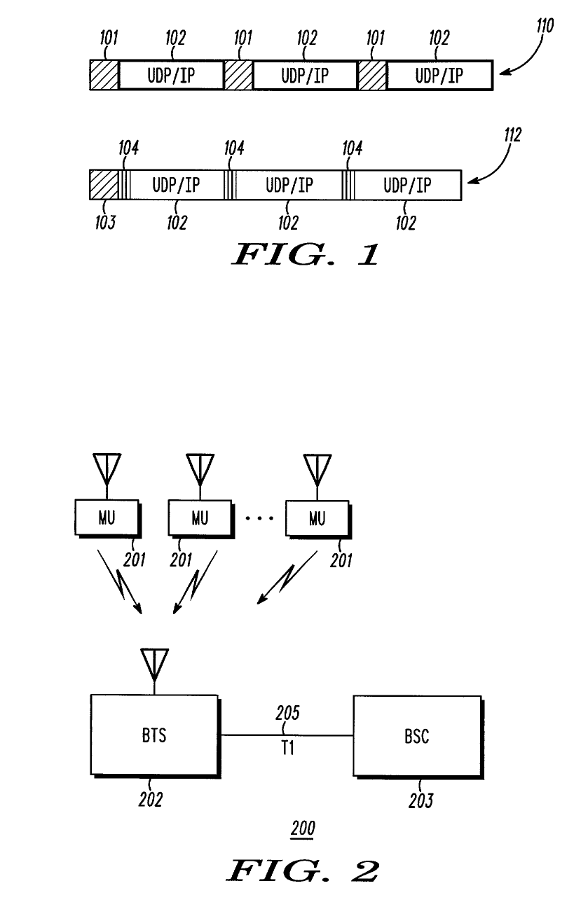

### DETAILED DESCRIPTION OF THE DRAWINGS

To address the above-mentioned need, a method and apparatus for multiplexing higher-layer packets into a single lower layer packet is described herein. In accordance with the preferred embodiment of the present invention, there exists an optimal frame size for a given bit error rate (BER). The optimal frame size provides the best trade off between frame size and capacity. Therefore, in the preferred embodiment of the present invention the BER for a transmission media is constantly monitored and the lower-layer packet size is adjusted dynamically based on the BER. By dynamically adjusting the lower-layer packet size an optimal packet size is continually maintained.

The present invention encompasses a method for data transmission. The method comprises the steps of receiving a plurality of higher-layer packets, determining an error rate of a transmission, and determining a lower-layer packet size based on the error rate. Higher-layer packets are multiplexed onto a lower-layer packet. The lower-layer packet is then transmitted over a transmission media.

The present invention additionally encompasses a method comprising the steps of receiving a plurality of UDP/IP packets from a plurality of users, determining an error rate, and determining a PPP packet size based on the error rate. The plurality of UDP/IP packets are multiplexed onto a PPP packet having a size equal to the PPP packet size, and then transmitted.

The present invention additionally encompasses an apparatus. The apparatus comprises a packet error estimator outputting a transmission error rate. The apparatus additionally comprises a multiplexer having the transmission error rate as an input, having a plurality of higher-layer packets as an input, determining a lower-layer packet size based on the transmission error rate, and multiplexing the plurality of higher-layer packets onto a lower-layer packet, wherein the lower-layer packet has a size equal to the lower-layer packet size.

Turning now to the drawings, wherein like numerals designate like components, FIG. 2 is a block diagram of communication system 200 in accordance with the preferred embodiment of the present invention. In accordance with the preferred embodiment of the present invention communication 200 is a cellular communication system utilizing a next generation CDMA architecture as described in the cdma2000 International Telecommunication Union-Radiocommunication (ITU-R) Radio Transmission Technology (RTT) Candidate Submission document. Although the description of the preferred embodiment of the present invention will be given below implemented within a CDMA communication system, in alternate embodiments other communication systems may be utilized. For example, the below-described multiplexing technique may be implemented within UMTS, Satellite or other Point-to-Point links carrying a large number of short packets, e.g. voice packets.

As shown in FIG. 2, multiple users, or mobile units 201, are communicating with base transceiver station (BTS) 202. BTS 202 multiplexes several user UDP/IP packets, after typically compressing the UDP/IP header for efficiency, onto a single PPP frame and transmits this information over a T1 line to BSC 203. As described in U.S. patent application Ser. No. 09/534,971, the interface between BSC 203 and BTS 202 is identified as an A3 interface, the specifics of which are described within the '971 application. In the preferred embodiment of the present invention, higher-layer packets arriving from mobile units 201 are multiplexed onto lower-layer frames and transmitted over communication link 205. In particular, multiple UDP/IP packets arriving from mobile units 201 are multiplexed via PPPmux onto a single PPPmux frame, or packet. It should be noted that each PPPmux packet comprises transmissions from multiple users.

As described above, there exists a tradeoff between the benefits of having many higher-layer packets within the lower-layer packet in order to reduce the packet overhead, and having a small number of higher-layer packets within the lower-layer packet so that an error in transmission does not require retransmitting many higher-layer packets and thus degrading quality of many calls (or packet flows). In order to address this issue, BTS 202 constantly monitors the error rate between BTS 202 and BSC 203 and adjusts the lower-layer packet size accordingly. More particularly, BTS 202 dynamically adjusts the amount of higher-layer UDP/IP packets contained within the lower-layer PPPmux packet.

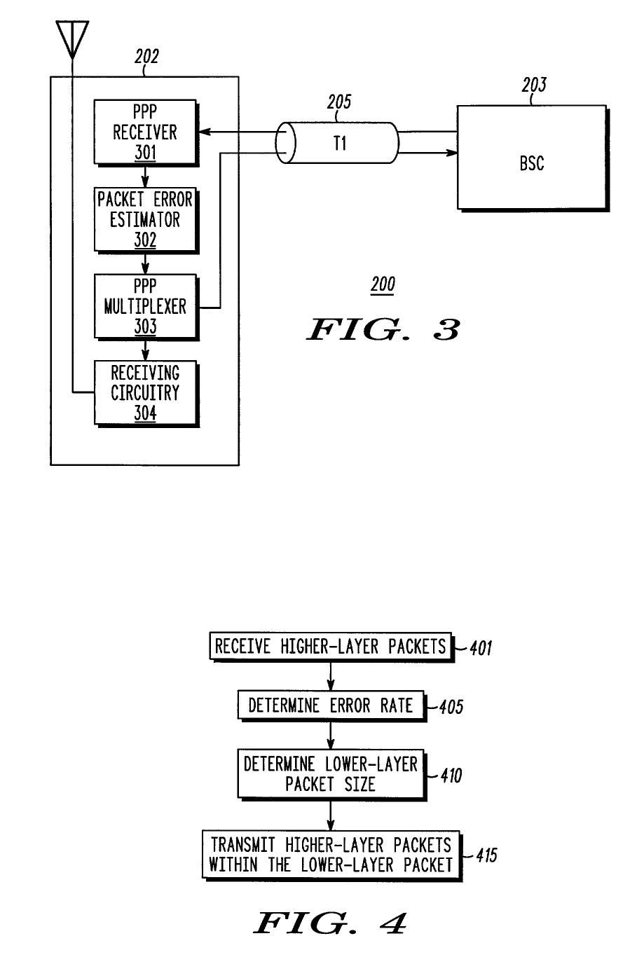

FIG. 3 is a more detailed block diagram of communication system 200 of FIG. 2 in accordance with the preferred embodiment of the present invention. As described in IEEE International Communications Conference 2001 (ICC2001) Proceedings PPPmux, A new protocol for Transporting Small Packets, BSC sends a context-state (CS) messages when it detects a packet loss. CS messages can carry multiple context identifications thus requesting updates for multiple flows. This allows BTS 202 to also keep track of the number of lost IP packets. In accordance with the preferred embodiment of the present invention Packet Error Estimator 301 estimates the current Packet Error Rate (PER), and adjusts the PPPmux frame size accordingly. More particularly, PPP receiver 301 checks to see whether a Context State (CS) message has been received. If so PPP receiver 301 transmits a message to Packet Error Estimator 302. Packet Error Estimator 302 keeps track of the number of CS messages received per second. Based on that input it computes an estimate of the average packet error. In the preferred embodiment of the present invention the packet error is the number of CS messages in last 5 seconds)/Total number of IP packets sent in last 5 seconds, however in alternate embodiments, the packet error may be calculated differently.

The Packet Error estimate (p_AT) is supplied as an input to PPP multiplexer 303. The PPP multiplexer 303 also has additional static inputs (not shown) such as target IP packet error rate γ, and average IP packet size, M. Based on p_HAT, PPP Multiplexer 303 estimates the bit error and thus estimates the packet error rate. In particular, the current bit error rate β is estimated from p_HAT, as follows:

β=1−(1−p_HAT)\hat{ }(1/M),

The packet error P, based on frame length is then given by:

P(FRAME_{—}LEN):=1−(1−β)\hat{ }FRAME_{—}LEN.

The maximum frame length (MAX_FRAME_LEN), and the maximum amount of higher-layer frames multiplexed onto a lower-layer frame (MAX_MUX_NO) are given by:

MAX_FRAME_{—}LEN=ARGMAX (P(FRAME LEN) )<γ

MAX_{—}MUX_NO=MAX_FRAME_{—}LEN/M.

In the preferred embodiment of the present invention FRAME_LEN is chosen so that the average EP packet error rate still satisfies the original constraint γ.

Certain links show bursty error behavior where typically the link would be virtually error free (BER˜10⁻¹⁰) but during the so-called “errored second” the BER would be high, e.g., ˜10⁻⁴. The above equations are utilized to specify the steady state values and during the error bursts the MAX_MUX_NO is updated as follows:

If (New Error beyond Timeout 1)

Start_Timer1( );

Else if (New Error within a Timeout 1)

If (MAX_MUX_NO >k)

MAX_MUX_NO= MAX_MUX_NO-k;

Else

MAX_MUX_NO=1;

If (Timer 2 not expired)

Cancel_Timer2( );

Start_Timer2( );

If (Timeout 2 Expires)

MAX_MUX_NO = MAX_MUX_NO_SS

Where MAX_MUX_NO_SS is the steady state value.

Updating MAX_MUX_NO as such allows PPPmux to change the number of multiplexed IP packet faster during the error burst. Timer 1 is used to accelerate the decrease of the number of packets multiplexed during an error burst. Timer 2 is used to recover the multiplexing size after the burst is over. In the preferred embodiment of the present invention IP packets are multiplexed as long as either the multiplexed frame length is below MAX_FRAME_LEN or the number of multiplexed frames is smaller than MAX_MUX_NO.

FIG. 4 is a flow chart showing operation of the communication system of FIG. 2 in accordance with the preferred embodiment of the present invention. The logic flow begins at step 401 where higher-layer packets are received by PPP multiplexer 303. As discussed above, in the preferred embodiment of the present invention the higher-layer packets comprise UDP/IP packets containing information transmitted from a plurality of mobile units. At step 405 an error rate is determined for lower-layer transmission. In particular, an error rate is determined for the link between BSC 203 and BTS 202. Based on the error rate, a lower-layer packet size is determined (step 410). As discussed above, the lower-layer packet size dictates an amount of higher-layer UDP/IP frames that can be multiplexed onto the lower-layer packet. Once an appropriate packet size has been determined, a plurality of higher-layer packets are multiplexed onto the lower-layer packet (step 415).

It should be noted that in the preferred embodiment of the present invention the lower-layer packet size is dynamically adjusted in a real-time manner every five seconds. In this way a continuous compromise is maintained between the benefits of having many UDP/IP packets within the PPPmux packet in order to reduce the packet overhead, and having a small number of UDP/IP packets within the PPPmux packet so that an error in transmission does not require retransmitting many UDP/IP packets.

While the invention has been particularly shown and described with reference to a particular embodiment, it will be understood by those skilled in the art that various changes in form and details may be made therein without departing from the spirit and scope of the invention. For example, although the above-description optimized packet size over a T1 line, one of ordinary skill in the art will recognize that packet size may be optimized as discussed above over any transmission media. It is intended that such changes come within the scope of the following claims.

1. A method for data transmission, the method comprising the steps of:
(a) receiving a plurality of higher-layer packets;
(b) determining an error rate of a transmission;
(c) determining a lower-layer packet size based on the error rate;
(d) multiplexing higher-layer packets onto a lower-layer packet, the lower-layer packet having a size as determined in step (C); and
(e) transmitting the lower-layer packet.

2. The method of claim 1 wherein the step of receiving the plurality of higher-layer packets comprises the step of receiving the plurality of higher-layer packets from a plurality of users.

3. The method of claim 1 wherein the step of receiving the plurality of higher-layer packets comprises the step of receiving a plurality of higher-layer TCP/IP packets.

4. The method of claim 1 wherein the step of determining the error rate comprises the step of determining a bit error rate (BER)

5. The method of claim 1 wherein the step of determining the lower-layer packet size comprises the step of determining an optimal number of higher-layer packets that can be multiplexed onto a single lower-layer packet.

6. The method of claim 1 wherein the step of multiplexing the higher-layer packets onto the lower-layer packet comprises the step of multiplexing UDP/IP packets onto a single PPP packet utilizing PPPmuxing techniques.

7. A method comprising the steps of:
receiving a plurality of UDP/IP packets from a plurality of users;
determining an error rate;
determining a PPP packet size based on the error rate;
multiplexing the plurality of UDP/IP packets onto a PPP packet having a size equal to the PPP packet size; and
transmitting the PPP packet.

8. The method of claim 7 wherein the step of receiving the plurality of UDP/IP packets comprises the step of receiving the plurality of UDP/IP packets from a plurality of remote or mobile users.

9. The method of claim 7 wherein the step of determining the error rate comprises the step of determining a bit error rate (BER).

10 The method of claim 7 wherein the step of determining the PPP packet size comprises the step of determining an optimal number of UDP/IP packets that can be multiplexed onto a single PPP packet.

11. The method of claim 7 wherein the step of multiplexing the plurality of UDP/IP packets onto the PPP packet comprises the step of utilizing PPPmuxing techniques to multiplex the plurality of UDP/IP packets onto the PPP packet.

12. An apparatus comprising:
a packet error estimator outputting a transmission error rate; and
a multiplexer having the transmission error rate as an input, having a plurality of higher-layer packets as an input, determining a lower-layer packet size based on the transmission error rate, and multiplexing the plurality of higher-layer packets onto a lower-layer packet, wherein the lower-layer packet has a size equal to the lower-layer packet size.

13. The apparatus of claim 12 wherein the multiplexer is a PPP multiplexer performing PPPmuxing.

14. The apparatus of claim 12 wherein the transmission error rate is bit error rate (BER)

15. The apparatus of claim 12 wherein the higher-layer packets comprise UDP/IP packets.

16. The apparatus of claim 12 wherein the lower-layer packet comprises a PPP packet.
